(19) United States
(12) Patent Application Publication
(10) Pub. No.: US 2017/0029318 A1
(43) Pub. Date: Feb. 2, 2017

(54) GLASS PLATE FOR HEAT TREATMENT

(71) Applicant: Asahi Glass Company, Limited, Chiyoda-ku (JP)

(72) Inventors: Yasumasa KATO, Tokyo (JP); Yutaka Ishikawa, Tokyo (JP); Junichiro Kase, Tokyo (JP)

(73) Assignee: Asahi Glass Company, Limited, Chiyoda-ku (JP)

(21) Appl. No.: 15/292,610

(22) Filed: Oct. 13, 2016

Related U.S. Application Data
(63) Continuation of application No. PCT/JP2015/061177, filed on Apr. 9, 2015.

(30) Foreign Application Priority Data
Apr. 14, 2014 (JP) 2014-082876

(51) Int. Cl. C03C 3/087; C03C 3/085; C03B 18/02; C03C 3/083

(52) U.S. Cl. CPC C03C 3/087; C03C 3/083; C03C 3/085; C03B 18/02

(57) ABSTRACT

An object of the present invention is to provide a glass plate capable of suppressing deformation of a glass product that is subject to load in a heat treatment process at a temperature not more than the glass strain point, such as chemical strengthening and coating. The present invention relates to a glass plate for heat treatment, in which the dimensionless index determined by the following formula is 1.6×10⁻⁴ or less, the average viscosity η is log η≦15.1 log Pa·s or less, the relationship between the fictive temperature T_{f} and the annealing point Tₐ is T_{f}≧(Tₐ+5), and when the plate thickness h of glass is 7×10⁻⁴ m or more, the displacement at the load point during the load applying time period is 78 μm or less: Dimensionless index=load F×load applying time period/(average viscosity η×plate thickness h²).

### TECHNICAL FIELD

The present invention relates to a glass plate for heat treatment. More specifically, the present invention relates to a glass plate for use in a display/opening member, which is to be imparted with a function or improved in the quality by being subjected to a heat treatment at a temperature not more than the strain point, such as chemical strengthening and coating.

### BACKGROUND ART

In recent years, the opportunity of applying chemical strengthening, coating, etc. to a glass plate with the aim of imparting a function or enhancing the quality is increasing. It is said in industry that a deformation does not remain when a load is applied to glass at a temperature not more than the glass strain point. However, a long-time heat treatment, despite at a temperature sufficiently lower than the glass strain point, generates a residual deformation that cannot be ignored from the viewpoint of product quality. In some cases, part of the deformation such as warpage attributable to a temperature distribution generated during cooling after heating remains as a final residual deformation. One cause of this residual deformation is that a glass product has a high-temperature glass structure due to cooling conditions at the time of production of the glass product. A method for enhancing chemical strengthening properties by performing a heat treatment at a temperature not more than the annealing point before chemically strengthening the glass has been proposed (Patent Documents 1 to 3).

### BACKGROUND ART DOCUMENT

### Patent Document

Patent Document 1: Japanese Patent No. 5,294,150

Patent Document 2: JP-T-2013-542164

Patent Document 3: JP-T-2014-501214

### SUMMARY OF THE INVENTION

### Problems that the Invention is to Solve

However, none of Patent Documents 1 to 3 refer to preventing deformation of glass during a heat treatment for changing a high-temperature glass structure to a low-temperature glass structure.

An object of the present invention is to provide a glass plate capable of suppressing deformation of a glass product that is subject to load in a heat treatment process at a temperature not more than the glass strain point, such as chemical strengthening and coating.

### Means for Solving the Problems

The present inventors have found that as to a glass plate for heat treatment, when the dimensionless index, the average viscosity, etc. thereof are controlled, a glass plate for heat treatment capable of suppressing deformation of a glass product that is subject to load in a heat treatment process at a temperature not more than the glass strain point, can be obtained. The present invention has been accomplished based on this finding. That is, the present invention is as follows.

<1> A glass plate for heat treatment, in which a dimensionless index determined by the following formula is 1.6×10⁻⁴ or less, an average viscosity η is log η≦15.1 log Pa·s or less, a relationship between a fictive temperature T_{f} and an annealing point Tₐ is T_{f}≧(Tₐ+5), and when a plate thickness h of glass is 7×10⁻⁴ m or more, a displacement at a load point during a load applying time period is 78 μm or less:

Dimensionless index=load F×load applying time period/(average viscosity η×plate thickness h²)

provided that a calculation method for the average viscosity η is as follows:

at a time when a glass plate having a width of 5 mm and a length of 35 mm is supported at intervals of 30 mm and subjected to three-point bending according to a Beam Bending method at a heat treatment temperature not more than a temperature given by subtracting 50 from a strain point (strain point−50) (unit: ° C.), the average viscosity η is determined by the following formula from the load F (unit: N) (≧0.98 N), the load applying time period (unit: seconds), and the displacement at the load point during the load applying time period:

$$η = \frac{{FL}^{3}}{144 V ( {bh}^{3} / 12 )}$$

η: average viscosity (unit: Pa·s),

L: supporting point distance (unit: m),

F: load (unit: N),

V: average deflection rate at load point (unit: m/s) (=displacement at load point÷load applying time period),

b: glass width (unit: m), and

h: plate thickness (unit: m).

<2> A glass plate for heat treatment, in which a dimensionless index determined by the following formula is 1.6×10⁻⁴ or less, a strain point is from 490 to 620° C., a relationship between a fictive temperature T_{f} and an annealing point Tₐ is (Tₐ+5)≦T_{f}≦(Tₐ+20), and when a plate thickness h of glass is 6.5×10⁻⁴ m or more, a displacement at a load point during a load applying time period is 78 μm or less:

Dimensionless index=load F×10,800 seconds/(average viscosity η×plate thickness h²)

provided that a calculation method for the average viscosity η is as follows:

at a time when a glass plate having a width of 5 mm and a length of 35 mm is supported at intervals of 30 mm and subjected to three-point bending by applying a load F for 10,800 seconds according to a Beam Bending method at a heat treatment temperature of 410° C. such that a value obtained by dividing the load F (unit: N) by a square of the plate thickness h (unit: m) becomes 4.0×10 (unit: N/m²), the average viscosity η is determined by the following formula from the displacement at the load point during the load applying time period:

$$η = \frac{{FL}^{3}}{144 V ( {bh}^{3} / 12 )}$$

η: average viscosity (unit: Pa·s),

L: supporting point distance (unit: m),

F: load (unit: N),

V: average deflection rate at load point (unit: m/s) (=displacement at load point/10,800 seconds),

b: glass width (unit: m), and

h: plate thickness (unit: m).

<3> A glass plate for heat treatment, in which a dimensionless index determined by the following formula is 1.6×10⁻⁴ or less, a strain point is from 490 to 620° C., a relationship between a fictive temperature T_{f} and a annealing point Tₐ is (Tₐ+5)≦T_{f}≦(Tₐ+20), and a plate thickness h of glass is less than 6.5×10⁻⁴ m:

Dimensionless index=load F×10,800 seconds/(average viscosity η×plate thickness h²)

provided that a calculation method for the average viscosity η is as follows:

at a time when a glass plate having a width of 5 mm and a length of 35 mm is supported at intervals of 30 mm and subjected to three-point bending by applying a load F for 10,800 seconds according to a Beam Bending method at a heat treatment temperature of 410° C. such that a value obtained by dividing the load F (unit: N) by a square of the plate thickness h (unit: m) becomes 6.5×10⁶ (unit: N/m²), the average viscosity η is determined by the following formula from a displacement at a load point during a load applying time period:

$$η = \frac{{FL}^{3}}{144 V ( {bh}^{3} / 12 )}$$

η: average viscosity (unit: Pa·s),

L: supporting point distance (unit: m),

F: load (unit: N),

V: average deflection rate at load point (unit: m/s) (=displacement at load point/10,800 seconds),

b: glass width (unit: m), and

h: plate thickness (unit: m).

<4> The glass plate for heat treatment according to <2> or <3>, in which the average viscosity η is log η≦15.1 log Pa·s.
<5> The glass plate for heat treatment according to any one of <1> to <4>, in which the glass plate has a size of 1,000 mm or more×1,000 mm or more.
<6> The glass plate for heat treatment according to any one of <1> to <5>, in which the glass plate is formed by a float process.

### Advantage of the Invention

According to the present invention, a glass plate for heat treatment capable of suppressing deformation of a glass product that is subject to load in a heat treatment process at a temperature not more than the glass strain point, such as chemical strengthening and coating, can be provided.

### BRIEF DESCRIPTION OF THE DRAWINGS

FIG. 1 is an explanatory view of the method for measuring the BB displacement by using a Beam Bending method so as to determine the average viscosity η.

### MODE FOR CARRYING OUT THE INVENTION

The mode for carrying out the present invention is described below, but the present invention is not limited to the following embodiment, and various modifications and replacements may be added to the following embodiment without departing from the scope of the present invention.

The kind of the glass plate for heat treatment (hereinafter, sometimes simply referred to as “glass plate”) of the present invention includes soda lime glass, and aluminosilicate glass, and the glass plate of the present invention is not limited in its kind.

Here, in the case where the glass plate of the present invention is used as chemically strengthened glass, the composition thereof is characterized by containing, in terms of molar percentage based on oxides, from 56 to 75% of SiO₂, from 1 to 20% of Al₂O₃, from 8 to 22% of Na₂O, from 0 to 10% of K₂O, from 0 to 14% of MgO, from 0 to 5% of ZrO₂, and from 0 to 12% of CaO. In the following, unless otherwise specified, the percentage expression indicates a content expressed in molar percentage. In addition to those described above, SrO, BaO, TiO₂, a sulfate, a chloride, a fluoride or other components may be contained.

The reasons for limiting the glass composition to the range above are described below.

SiO₂ is known to be a component forming a network structure in a glass microstructure and is a major component constituting glass. The content of SiO₂ is 56% or more, preferably 60% or more, more preferably 63% or more, still more preferably 65% or more. The content of SiO₂ is 75% or less, preferably 73% or less, more preferably 71% or less.

The SiO₂ content of 56% or more is advantageous in terms of stability or weather resistance as glass. On the other hand, the SiO₂ content of 75% or less is advantageous in terms of meltability and formability.

Al₂O₃ has an action of enhancing the ion exchange performance in chemical strengthening, and among others, the action to enhance the surface compressive stress (CS) is large. This is also known as a component for enhancing the weather resistance of glass and in addition, has an action of suppressing entry of tin from the bottom surface during float forming. The content of Al₂O₃ is 1% or more, preferably 2% or more, more preferably 2.7% or more, still more preferably 3.2% or more. The content of Al₂O₃ is 20% or less, preferably 17% or less, more preferably 12% or less, still more preferably 10% or less, yet still more preferably 7% or less.

When the content of Al₂O₃ is 1% or more, a desirable CS value is obtained by ion exchange and in addition, an effect of suppressing tin entry is obtained. On the other hand, when the content of Al₂O₃ is 20% or less, the devitrification temperature does not greatly rise even in the case where the viscosity of glass is high, which is advantageous in terms of melting and forming in a soda lime glass production line.

The total content of SiO₂ and Al₂O₃(SiO₂+Al₂O₃) is preferably 80% or less. If the total content exceeds 80%, the viscosity of glass at a high temperature may be increased, making melting difficult. The total content is more preferably 79% or less, still more preferably 78% or less. The (SiO₂+Al₂O₃) is preferably 69% or more. The total content of 69% or more is advantageous in terms of crack resistance when an indentation is impressed. The total content is more preferably 70% or more, still more preferably 72% or more.

Na₂O is an essential component for forming a surface compressive stress layer by ion exchange and has an action of deepening the depth of the compressive stress layer (DOL). In addition, this is a component for lowering the high-temperature viscosity and devitrification temperature of glass and improving the meltability and formability of glass. The content of Na₂O is 8% or more, preferably 12% or more, more preferably 13% or more. The content of Na₂O is 22% or less, preferably 17% or less, more preferably 15% or less. When the content of Na₂O is 8% or more, a desired compressive stress layer can be formed by ion exchange. On the other hand, when the content of Na₂O is 22% or less, sufficient weather resistance is obtained.

K₂O is not essential but may be contained because of its effect of increasing the ion exchange rate and deepening DOL. On the other hand, if the content of K₂O is too large, this leads to an increase in the thermal expansion coefficient as well as in the stress generated when the temperature distribution becomes non-uniform. In the case of containing K₂O, the content thereof is preferably 10% or less, more preferably 8% or less, still more preferably 6% or less. When the content of K₂O is 10% or less, the stress generated due to thermal expansion can be prevented from increasing extremely.

MgO is not essential but is a component capable of stabilizing glass. The content of MgO is preferably 2% or more, more preferably 6% or more, still more preferably 8% or more. The content of MgO is preferably 14% or less, more preferably 12% or less, still more preferably 11% or less. When the content of MgO is 2% or more, the chemical resistance of glass is improved, and the meltability at a high temperature is also improved, making it difficult for devitrification to occur. On the other hand, when the content of MgO is 14% or less, the difficulty of causing devitrification is maintained, and a sufficient ion exchange rate can be obtained.

ZrO₂ is not essential but is generally known to have an action of increasing the surface compressive stress in chemical strengthening. However, even when a small amount of ZrO₂ is contained, its effect is not large for the increase in cost. Accordingly, ZrO₂ may be contained in an arbitrary ratio to an extent permitted by cost. In the case of containing ZrO₂, the content thereof is preferably 5% or less.

CaO is not essential but is a component capable of stabilizing glass. CaO has a tendency to inhibit exchange of an alkali ion and therefore, it is preferable to decrease the content thereof or not to contain the component, particularly when an increase in DOL is intended. On the other hand, in order to enhance the chemical resistance, the content thereof is preferably 1% or more, more preferably 3% or more, still more preferably 4% or more. In the case of containing CaO, the content thereof is 12% or less, preferably 10% or less, more preferably 8% or less, still more preferably 6% or less. When the content of CaO is 12% or less, a sufficient ion exchange rate is maintained, and the desired DOL can be obtained.

SrO is not essential but may be contained for the purpose of reducing the high-temperature viscosity of glass and lowering the devitrification temperature. SrO has an action of reducing the ion exchange efficiency and therefore, it is preferable not to contain this component particularly when an increase in DOL is intended. In the case of containing SrO, the content thereof is preferably 3% or less, more preferably 2% or less, still more preferably 1% or less.

BaO is not essential but may be contained for the purpose of reducing the high-temperature viscosity of glass and lowering the devitrification temperature. BaO has an action of increasing the specific gravity of glass and therefore, it is preferable not to contain this component when weight reduction is intended. In the case of containing BaO, the content thereof is preferably 3% or less, more preferably 2% or less, still more preferably 1% or less.

A lot of TiO₂ is present in natural raw materials and known to serve as a coloring source for yellowing. The content of TiO₂ is preferably 0.3% or less, more preferably 0.2% or less, still more preferably 0.1% or less. If the content of TiO₂ exceeds 0.3%, glass is tinged with yellow.

Other than these, as a refining agent in melting the glass, a sulfate, a chloride, a fluoride, etc. may be contained appropriately. The glass of the present invention is essentially composed of the above-described components but may contain other components as long as the object of the present invention is not impaired. In the case of containing such components, the total content of these components is preferably 5% or less, more preferably 3% or less, and typically 1% or less. Such other components are illustratively described below.

ZnO may be contained, for example, up to 2% so as to improve the high-temperature meltability of glass. However, in the case of production by a float process, this component is reduced in a float bath and works out to a product defect and therefore, it is preferable not to contain the component.

B₂O₃ may be contained in the range of less than 1% so as to enhance the high-temperature meltability or the glass strength. In general, when B₂O₃ is contained simultaneously with an alkali component such as Na₂O or K₂O, volatilization is intensified to significantly erode bricks and therefore, it is preferable to contain substantially no B₂O₃.

Li₂O is a component lowering the strain point, thereby facilitating occurrence of stress relaxation and in turn, making it impossible to obtain a stabilized surface compressive stress layer, and is therefore preferably not contained, and even in the case of containing this component, the content thereof is preferably less than 1%, more preferably 0.3% or less, still more preferably less than 0.1%.

The plate thickness h of glass is preferably 1.1 mm or less, more preferably 0.8 mm or less, still more preferably 0.6 mm or less. On the other hand, the plate thickness of glass is preferably 0.3 mm or more, more preferably 0.4 mm or more, still more preferably 0.5 mm or more.

The “fictive temperature T_{f}” is a parameter reflecting the heat history of glass and is an indicator defined as a temperature allowing the glass to assume an equilibrium structure when heated. Specifically, when glass is heat-treated at an arbitrary temperature until reaching a thermodynamic equilibrium state and then rapidly cooled to room temperature at a cooling rate of 10,000° C./min or more, glass frozen in the structure at the heat treatment temperature is obtained. The heat treatment temperature at this time is defined as a fictive temperature T_{f} of the glass. The method for measuring the fictive temperature T_{f} is as follows.

First, with respect to a plurality of heat treatment temperatures, the glass obtained by rapid cooling is measured for the refractive index, and a calibration curve of the fictive temperature and the refractive index is prepared. Subsequently, the refractive index of a glass sample for fictive temperature T_{f} measurement is measured. The fictive temperature T_{f} of the glass sample is then defined from the measured refractive index by using the previously prepared calibration curve.

A fictive temperature T_{f} that is not less than the temperature (annealing point Tₐ+5° C.) given by adding 5 to the later-described annealing point Tₐ (i.e., fictive temperature T_{f}≧(annealing point Tₐ+5)) is advantageous in view of production by float forming. The fictive temperature is more preferably not less than annealing point+10° C. (i.e., fictive temperature T_{f}≦(annealing point Tₐ+10)). The fictive temperature T_{f} is preferably a temperature not more than the temperature given by adding 20 to the annealing point Tₐ (i.e., fictive temperature T_{f}≦(annealing point Tₐ+20)). A fictive temperature T_{f} that is a temperature not more than the temperature given by adding 20 to the annealing point Tₐ (i.e., fictive temperature T_{f}≦(annealing point Tₐ+20)) is preferred, because reduction in the low-temperature viscosity and increase in the deformation can be prevented from being caused due to insufficient annealing.

The “annealing point Tₐ” is a temperature measured based on the method of ASTM C336 and depends on the composition, etc. of glass. The annealing point Tₐ of soda lime glass is typically about 550° C.

The “strain point” is a temperature measured based on the method of ASTM C336. The strain point is from 490 to 520° C. in soda lime glass and is from 520 to 620° C. in aluminosilicate glass suited for a chemical strengthening treatment. If the strain point is too low, the glass heat-treated at the same temperature undergoes an increase in the deformation or the amount of thermal contraction and is not suited for a heat treatment such as chemical strengthening or film deposition.

The strain point of the glass plate of this embodiment is preferably 490° C. or more, more preferably 505° C. or more. When the strain point is 490° C. or more, the shape stability at the time of heat treatment is improved. The strain point of the glass plate of this embodiment is preferably 620° C. or less, more preferably 600° C. or less. When the strain point is 620° C. or less, good formability is maintained particularly in the float process.

The viscosity of glass depends on the composition of the glass when the temperature of glass is the same. In the case of soda lime glass, for example, as the content of an alkali metal oxide (e.g., Na₂O, K₂O) in the glass is smaller, the viscosity of glass is higher. In the case where the composition of glass is the same, the viscosity of glass decreases as the temperature of glass rises.

The “dimensionless index” is, as shown in the following formula, a value obtained by dividing the product of the load F (unit: N) and the load applying time period “time” (unit: seconds) by the product of the later-described average viscosity η (unit: Pa·s) and a square of plate thickness h (unit: m).

Dimensionless index=F×“time”/(η×h²)

When the dimensionless index is 1.6×10⁻⁴ or less, the deformation of glass during heat treatment is reduced to a level posing no problem in practice. From the viewpoint of preventing deformation of glass during heat treatment, the dimensionless index is preferably 1.4×10⁻⁴ or less, more preferably 1.3×10⁻⁴ or less.

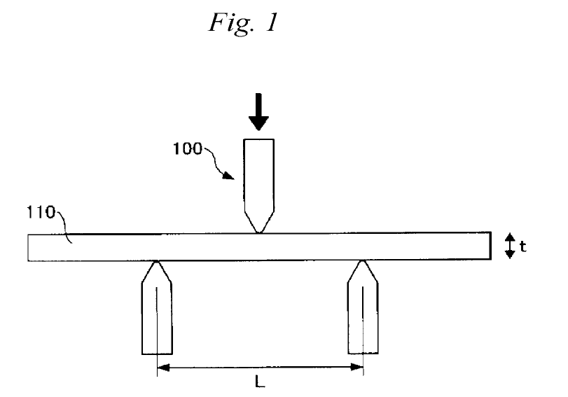

At the time when a test piece 110, i.e., a glass plate having a width of 5 mm and a length of 35 mm, is supported at intervals of 30 mm as illustrated in FIG. 1 and subjected to three-point bending by using a testing machine 100 according to a Beam Bending method (BB method) at a heat treatment temperature not more than the temperature given by subtracting 50 from the strain point (strain point−50) (unit: ° C.), the average viscosity η (unit: Pa·s) is determined by the following formula from the load F (unit: N) (≧0.98 N), the load applying time period (unit: seconds), and the displacement (BB displacement) at the load point during the load applying time period.

$$η = \frac{{FL}^{3}}{144 V ( {bh}^{3} / 12 )}$$

Here, η is the average viscosity (unit: Pa·s), L is the supporting point distance (unit: m), F is the load (unit: N), V is the average deflection rate at load point (unit: m/s) (=BB displacement÷load applying time period), b is the glass width (unit: m), and h is the plate thickness (unit: m).

When the logarithm log η of the average viscosity η is log η1≦15.1 (unit: log Pa·s), production by the float process is facilitated. The average viscosity is more preferably log η≦15.0 (unit: log Pa·s) or less.

In the case where the plate thickness of glass is 0.65 mm or more, particularly 0.7 mm or more, when the BB displacement is 78 μm or less, the glass is not too soft and is insusceptible to deformation during heat treatment.

The BB displacement can be measured by the method described later in Test Examples.

### Examples

The present invention is described specifically by referring to Examples, etc., but the present invention is not limited to these Examples.

In Test Examples, a plurality of flat soda lime glass plates produced by the float process were prepared. For the measurement, the glass plates produced by the float process were separated into individual pieces. In the glass plate, the width was 5 mm, the length was 35 mm, and the plate thickness was 0.55 mm or 0.7 mm. Here, the glass plate used in Test Examples was a glass plate of which composition contains, in terms of molar percentage based on oxides, from 56 to 75% of SiO₂, from 1 to 20% of A₂O₃, from 8 to 22% of Na₂O, from 0 to 10% of K₂O, from 0 to 14% of MgO, from 0 to 5% of ZrO₂, and from 0 to 12% of CaO.

Out of Test Examples, in Examples 3 to 5, 7 to 9 and 11 to 15, the conditions of the BB method (BB conditions) are as follows. Glass was processed into a sheet glass having a size of a length of 35 mm, a width of 5 mm, and a plate thickness of 0.55 mm or 0.7 mm. The processing was performed by machining such as cutting and polishing. If heat is applied to glass during processing, the structure temperature of glass is changed, and for this reason, the temperature was maintained at 200° C. or less. A sheet glass processed into the measurement shape was placed on the top of a receiving edge spanning a width of 30 mm by aligning the sample center with the center of the receiving edge span and adjusted so that a pressing edge could abut on the central part of the sample. The glass was heated at a heat treatment temperature of 410° C., and such a load F that the value obtained by dividing the load F by a square of the plate thickness h becomes from 4.0×10⁶ to 6.5×10⁶ (unit: N/m²) was applied for 10,800 seconds.

The BB method was conducted in the following manner. The glass of each Example was heated up to 410° C. at 10° C./min. At the point of exceeding 200° C., a load was applied and after reaching 410° C., the glass was held for 10,800 seconds by keeping applying the load. The temperature was then lowered to 200° C., and the load was removed. Thereafter, the glass was cooled to room temperature.

As for the BB displacement, the warpage shape of glass before and after conducting the BB method was measured. More specifically, the glass was placed on a horizontal surface such that the center of glass is convexed, the maximum and minimum heights were measured in the central portion and both end portions, and the difference therebetween was taken as the warpage amount of glass. The warpage amount was measured by means of a non-contact three-dimensional measuring system, NH-3MAS, manufactured by Mitaka Kohki Co., Ltd. The difference in the warpage amount between before and after conducting the BB method was taken as the BB displacement. Here, due to limitation of the measuring method, as for the actually measured length, the warpage amount is a warpage amount as measured in length of 34 mm resulting from subtraction of 0.5 mm at both ends from 35 mm of the length of the glass plate.

In Example 1, the same BB conditions as in Example 3 were employed except that the value obtained by dividing the load F by a square of the plate thickness h was set to 3.2×10⁶ N/m² that was outside the range described above. In Example 2, the same BB conditions as in Example 3 were employed except that the heat treatment temperature was 350° C. In Examples 6 and 10, the same BB conditions as in Example 3 were employed except that the heat treatment temperature was 450° C.

The results of annealing point, strain point, fictive temperature, BB conditions, average viscosity η, BB displacement, float formability, large-plate heat-treatment deformability, and (dimensionless) index are shown in Table 1. Here, as for the float formability, whether it is suitable or not for producing glass by the float process was judged by the relationship between the fictive temperature and the annealing point. As for the large-plate heat-treatment deformability, a large glass plate (1,300 mm×1,100 mm) was produced and whether the glass plate is deformed or not when heat-treated was determined and judged by the dimensionless index. Examples 1 to 9 are Working Examples of the present invention, and Examples 10 to 15 are Comparative Examples. Examples 1 to 6, 10 and 12 to 14 are a glass plate manufactured by controlling the average viscosity at the time of production by the float process, and Example 15 is a glass plate manufactured under general annealing conditions without intentionally controlling the average viscosity at the time of production by the float process. Examples 7 to 9 are not a glass plate produced by the float process but are a glass plate produced in a crucible.

TABLE 1

| | | | | | | | Load/Square |
|---|---|---|---|---|---|---|---|
| | Fictive | | Annealing | Strain | Plate | BB Conditions | of Plate |
| | Temperature | Annealing | Point + 5 | Point | Thickness | Temperature × Time × | Thickness |
| Example | [° C.] | Point [° C.] | [° C.] | [° C.] | [mm] | Load | [N/m²] |
| Example 1 | 569.7 | 550 | 555 | 509 | 0.55 | 410° C. × 3 hr × 0.98 N | 3.2 × 10⁶ |
| Example 2 | 569.7 | 550 | 555 | 509 | 0.55 | 350° C. × 3 hr × 1.96 N | 6.5 × 10⁶ |
| Example 3 | 621 | 606 | 611 | 556 | 0.55 | 410° C. × 3 hr × 1.96 N | 6.5 × 10⁶ |
| Example 4 | 569.7 | 550 | 555 | 509 | 0.7 | 410° C. × 3 hr × 1.96 N | 4.0 × 10⁶ |
| Example 5 | 621 | 606 | 611 | 556 | 0.7 | 410° C. × 3 hr × 1.96 N | 4.0 × 10⁶ |
| Example 6 | 621 | 606 | 611 | 556 | 0.7 | 450° C. × 3 hr × 1.96 N | 4.0 × 10⁶ |
| Example 7 | 562 | 550 | 555 | 509 | 0.55 | 410° C. × 3 hr × 1.96 N | 6.5 × 10⁶ |
| Example 8 | 557 | 550 | 555 | 509 | 0.55 | 410° C. × 3 hr × 1.96 N | 6.5 × 10⁶ |
| Example 9 | 565 | 550 | 555 | 509 | 0.55 | 410° C. × 3 hr × 1.96 N | 6.5 × 10⁶ |
| Example 10 | 621 | 606 | 611 | 556 | 0.55 | 450° C. × 3 hr × 1.96 N | 6.5 × 10⁶ |
| Example 11 | 511 | 550 | 555 | 509 | 0.55 | 410° C. × 3 hr × 1.96 N | 6.5 × 10⁶ |
| Example 12 | 560.2 | 541 | 546 | 500 | 0.7 | 410° C. × 3 hr × 1.96 N | 4.0 × 10⁶ |
| Example 13 | 566.2 | 541 | 546 | 497 | 0.7 | 410° C. × 3 hr × 1.96 N | 4.0 × 10⁶ |
| Example 14 | 573.1 | 549 | 554 | 506 | 0.7 | 410° C. × 3 hr × 1.96 N | 4.0 × 10⁶ |
| Example 15 | 569.7 | 550 | 555 | 509 | 0.55 | 410° C. × 3 hr × 1.96 N | 6.5 × 10⁶ |

| | | | BB | | Large-Plate |
|---|---|---|---|---|---|
| | | log η | Displacement | Float | Heat Treatment |
| Example | Index | [log Pa · s] | [μm] | Formability | Deformability |
| Example 1 | 8.696 × 10⁻⁵ | 14.605 | 71.15 | A | A |
| Example 2 | 6.015 × 10⁻⁵ | 15.066 | 49.21 | A | A |
| Example 3 | 7.203 × 10⁻⁵ | 14.987 | 58.93 | A | A |
| Example 4 | 1.211 × 10⁻⁴ | 14.553 | 77.82 | A | A |
| Example 5 | 4.155 × 10⁻⁵ | 15.017 | 26.71 | A | A |
| Example 6 | 9.382 × 10⁻⁵ | 14.663 | 60.31 | A | A |
| Example 7 | 1.383 × 10⁻⁴ | 14.704 | 113.14 | A | A |
| Example 8 | 1.259 × 10⁻⁴ | 14.745 | 103.04 | A | A |
| Example 9 | 1.587 × 10⁻⁴ | 14.644 | 129.84 | A | A |
| Example 10 | 1.645 × 10⁻⁴ | 14.629 | 134.58 | A | C |
| Example 11 | 4.495 × 10⁻⁵ | 15.192 | 36.78 | C | AA |
| Example 12 | 1.340 × 10⁻⁴ | 14.508 | 86.13 | A | C |
| Example 13 | 1.216 × 10⁻⁴ | 14.551 | 78.17 | A | C |
| Example 14 | 1.400 × 10⁻⁴ | 14.489 | 90.01 | A | C |
| Example 15 | 1.770 × 10⁻⁴ | 14.597 | 144.83 | A | C |

Table 1 reveals the followings.

In Examples 1 to 9, the dimensionless index was 1.6×10⁻⁴ or less, the average viscosity η was log η≦15.1 (unit: log Pa·s), the fictive temperature satisfied the relationship of (annealing point Tₐ+5)≦fictive temperature T_{f}≦(annealing point Tₐ+20), the BB displacement was 78 μm or less when the plate thickness h was 0.65 mm or more, and it was understood that the float formability and the large-plate heat-treatment deformability were excellent.

On the other hand, in Examples 10 and 15, the float formability was excellent, but the dimensionless index was high and the large-plate heat-treatment deformability was not excellent. In Example 11, the large-plate heat-treatment deformability was excellent, but the average viscosity η was high and the float formability was not excellent. In Examples 12 to 14, the float formability was excellent, but the BB displacement was high and the large-plate heat-treatment deformability was not excellent.

While the invention has been described in detail and with reference to specific embodiments thereof, it will be apparent to one skilled in the art that various changes and modifications can be made therein without departing from the spirit and scope of the invention. This application is based on Japanese Patent Application (Patent Application No. 2014-082876) filed on Apr. 14, 2014, the contents of which are incorporated herein by way of reference.
100 Testing machine
110 Test piece

1. A glass plate for heat treatment, wherein a dimensionless index determined by the following formula is 1.6×10⁻⁴ or less, an average viscosity η is log η≦15.1 log Pa·s or less, a relationship between a fictive temperature T_{f} and an annealing point Tₐ is T_{f}≧(Tₐ+5), and when a plate thickness h of glass is 7×10⁻⁴ m or more, a displacement at a load point during a load applying time period is 78 m or less:
Dimensionless index=load F×load applying time period/(average viscosity η×plate thickness h²)
provided that a calculation method for the average viscosity η is as follows:
at a time when a glass plate having a width of 5 mm and a length of 35 mm is supported at intervals of 30 mm and subjected to three-point bending according to a Beam Bending method at a heat treatment temperature not more than a temperature given by subtracting 50 from a strain point (strain point−50) (unit: ° C.), the average viscosity η is determined by the following formula from the load F (unit: N) (≧0.98 N), the load applying time period (unit: seconds), and the displacement at the load point during the load applying time period:
$$η = \frac{{FL}^{3}}{144 V ( {bh}^{3} / 12 )}$$
η: average viscosity (unit: Pa·s),
L: supporting point distance (unit: m),
F: load (unit: N),
V: average deflection rate at load point (unit: m/s) (=displacement at load point÷load applying time period),
b: glass width (unit: m), and
h: plate thickness (unit: m).

2. A glass plate for heat treatment, wherein a dimensionless index determined by the following formula is 1.6×10⁻⁴ or less, a strain point is from 490 to 620° C., a relationship between a fictive temperature T_{f} and an annealing point Tₐ is (Tₐ+5)≦T_{f}≦(Tₐ+20), and when a plate thickness h of glass is 6.5×10⁻⁴ m or more, a displacement at a load point during a load applying time period is 78 μm or less:
Dimensionless index=load F×10,800 seconds/(average viscosity η×plate thickness h²)
provided that a calculation method for the average viscosity η is as follows:
at a time when a glass plate having a width of 5 mm and a length of 35 mm is supported at intervals of 30 mm and subjected to three-point bending by applying a load F for 10,800 seconds according to a Beam Bending method at a heat treatment temperature of 410° C. such that a value obtained by dividing the load F (unit: N) by a square of the plate thickness h (unit: m) becomes 4.0×10⁶ (unit: N/m²), the average viscosity η is determined by the following formula from the displacement at the load point during the load applying time period:
$$η = \frac{{FL}^{3}}{144 V ( {bh}^{3} / 12 )}$$
η: average viscosity (unit: Pa·s),
L: supporting point distance (unit: m),
F: load (unit: N),
V: average deflection rate at load point (unit: m/s) (=displacement at load point/10,800 seconds),
b: glass width (unit: m), and
h: plate thickness (unit: m).

3. A glass plate for heat treatment, wherein a dimensionless index determined by the following formula is 1.6×10⁻⁴ or less, a strain point is from 490 to 620° C., a relationship between a fictive temperature T_{f} and a annealing point Tₐ is (Tₛ+5)≦T_{f}≦(Tₐ=+20), and a plate thickness h of glass is less than 6.5×10⁻⁴ m:
Dimensionless index=load F×10,800 seconds/(average viscosity η×plate thickness h²)
provided that a calculation method for the average viscosity η is as follows:
at a time when a glass plate having a width of 5 mm and a length of 35 mm is supported at intervals of 30 mm and subjected to three-point bending by applying a load F for 10,800 seconds according to a Beam Bending method at a heat treatment temperature of 410*C such that a value obtained by dividing the load F (unit: N) by a square of the plate thickness h (unit: m) becomes 6.5×10⁶ (unit: N/m²), the average viscosity η is determined by the following formula from a displacement at a load point during a load applying time period:
$$η = \frac{{FL}^{3}}{144 V ( {bh}^{3} / 12 )}$$
η: average viscosity (unit: Pa·s),
L: supporting point distance (unit: m),
F: load (unit: N),
V: average deflection rate at load point (unit: m/s) (=displacement at load point/10,800 seconds),
b: glass width (unit: m), and
h: plate thickness (unit: m).

4. The glass plate for heat treatment according to claim 2, wherein the average viscosity η is log η≦15.1 log Pa·s.

5. The glass plate for heat treatment according to claim 3, wherein the average viscosity η is log η≦15.1 log Pa·s.

6. The glass plate for heat treatment according to claim 1, wherein the glass plate has a size of 1,000 mm or more×1,000 mm or more.

7. The glass plate for heat treatment according to claim 2, wherein the glass plate has a size of 1,000 mm or more×1,000 mm or more.

8. The glass plate for heat treatment according to claim 3, wherein the glass plate has a size of 1,000 mm or more×1,000 mm or more.

9. The glass plate for heat treatment according to claim 1, wherein the glass plate is formed by a float process.

10. The glass plate for heat treatment according to claim 2, wherein the glass plate is formed by a float process.

11. The glass plate for heat treatment according to claim 3, wherein the glass plate is formed by a float process.
